(19) United States
(12) Patent Application Publication
(10) Pub. No.: US 2022/0237268 A1
(43) Pub. Date: Jul. 28, 2022

(54) INFORMATION PROCESSING METHOD, INFORMATION PROCESSING DEVICE, AND PROGRAM

(71) Applicant: SONY GROUP CORPORATION, Tokyo (JP)

(72) Inventors: Kento NAKADA, Tokyo (JP); Masanori MIYAHARA, Tokyo (JP); Yuji HORIGUCHI, Kanagawa (JP); Hiroshi IIDA, Tokyo (JP); Shingo TAKAMATSU, Tokyo (JP)

(73) Assignee: SONY GROUP CORPORATION, Tokyo (JP)

(21) Appl. No.: 17/616,420

(22) PCT Filed: Jun. 1, 2020
(86) PCT No.: PCT/JP2020/021541

§ 371 Date: Dec. 3, 2021

(30) Foreign Application Priority Data
Jun. 11, 2019 (JP) 2019-108723

(51) Int. Cl. G06F 21/14; G06F 3/04842; G06N 20/00

(52) U.S. Cl. CPC G06F 21/14; G06N 20/00; G06F 3/04842

(57) ABSTRACT

There is provided an information processing method, an information processing device, and a program that facilitates a security measure for a machine learning model or an API for using the machine learning model, the information processing system including one or more information processing devices controls a user interface for performing a setting related to security of a machine learning model, and generates the machine learning model corresponding to content set via the user interface. The present technology can be applied to, for example, a system that generates and discloses, for example, a machine learning model or an API for using the machine learning model.

### TECHNICAL FIELD

The present technology relates to an information processing method, an information processing device, and a program, and more particularly to an information processing method, an information processing device, and a program that facilitates a security measure for a machine learning model.

### BACKGROUND ART

In recent years, machine learning has been utilized in various fields (refer to Patent Document 1, for example).

Furthermore, in the future, for example, (parameters for) a machine learning model such as a neural network or a linear discriminator, or an application programming interface (API) for using a machine learning model (hereinafter, referred to as a machine learning API) will be disclosed, and provision of services that can be utilized by users will be widespread.

### CITATION LIST

### Patent Document

Patent Document 1: WO 2016/136056

### SUMMARY OF THE INVENTION

### Problems to be Solved by the Invention

However, there are known a method for abusing a machine learning model or machine learning API and identifying data with confidentiality (hereinafter, referred to as confidential data) used for learning, and a method for intentionally modifying input data so as to obtain a result convenient for users. Here, the confidential data is, for example, data including personal information, data under a privacy non-disclosure agreement at a time of data collection, or the like. Therefore, in a case where a machine learning model or a machine learning API is disclosed, it is necessary to take a measure against these.

The present technology has been developed to solve such a problem mentioned above and to facilitate a security measure for a machine learning model or a machine learning API.

### Solutions to Problems

In an information processing method according to one aspect of the present technology, an information processing system including one or more information processing devices controls a user interface for performing a setting related to security for a machine learning model, and generates the machine learning model corresponding to content set via the user interface.

An information processing device according to one aspect of the present technology includes a user interface control unit that controls a user interface for performing a setting related to security of a machine learning model, and a learning unit that generates the machine learning model corresponding to content set via the user interface.

A program according to one aspect of the present technology causes a computer to execute processing including controlling a user interface for performing a setting related to security of a machine learning model, and generating the machine learning model corresponding to content set via the user interface.

In one aspect of the present technology, a user interface for performing a setting related to security of a machine learning model is controlled, and the machine learning model corresponding to content set via the user interface is generated.

### BRIEF DESCRIPTION OF DRAWINGS

FIG. 1 is a diagram for describing a differential privacy mechanism.

FIG. 2 is a block diagram illustrating an embodiment of an information processing system to which the present technology is applied.

FIG. 3 is a block diagram illustrating a configuration example of a server.

FIG. 4 is a flowchart for describing learning processing.

FIG. 5 is a diagram illustrating an example of a main setting screen.

FIG. 6 is a flowchart for describing details of confidential data setting processing.

FIG. 7 is a diagram illustrating an example of a disclosure method setting screen.

FIG. 8 is a diagram illustrating an example of a parameter δ setting screen.

FIG. 9 is a diagram for describing details of attack detection setting processing.

FIG. 10 is a diagram illustrating an example of an attack detection setting screen.

FIG. 11 is a flowchart for describing details of learning execution processing.

FIG. 12 is a diagram illustrating a first example of a parameter ε setting screen.

FIG. 13 is a diagram illustrating a second example of a parameter ε setting screen.

FIG. 14 is a diagram illustrating an example of a help screen.

FIG. 15 is a diagram illustrating an example of a setting screen for a parameter ε and the allowable number of API accesses.

FIG. 16 is a flowchart for describing estimation processing.

FIG. 17 is a flowchart for describing attack detection history display processing.

FIG. 18 is a diagram illustrating an example of an attack detection history display screen.

FIG. 19 is a diagram illustrating a configuration example of a computer.

### MODE FOR CARRYING OUT THE INVENTION

Hereinafter, an embodiment for carrying out the present technology will be described. The description will be made in the following order.

1. Security measure for machine learning model applied to present technology

2. Embodiment

3. Modifications

4. Others

### 1. Security Measure for Machine Learning Model

First, a security measure for a machine learning model applied to the present technology will be briefly described.

<Differential Privacy Mechanism>

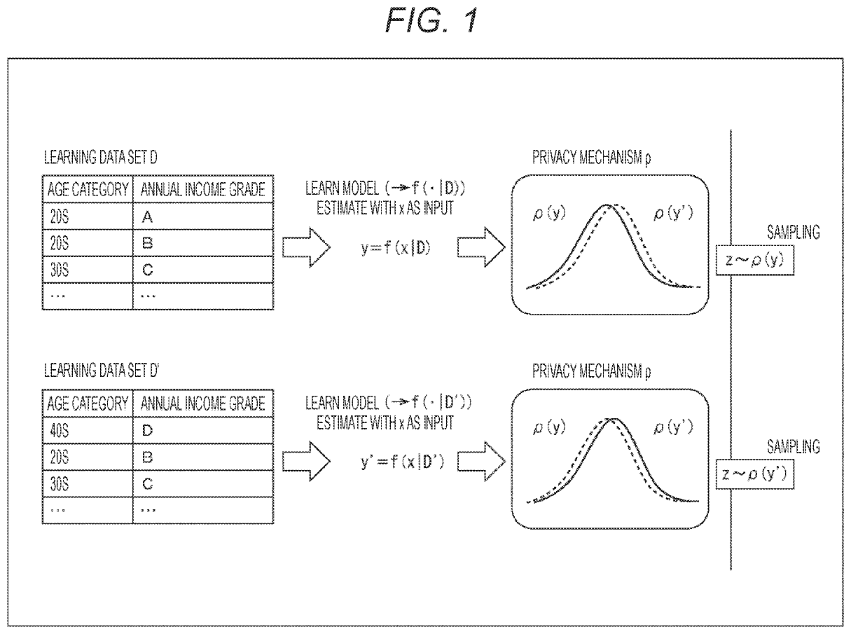

First, a differential privacy mechanism will be described with reference to FIG. 1.

Conventionally, there is known a risk that confidential data used for learning by a machine learning model is inversely estimated by repeatedly requesting estimation processing to the machine learning model or a machine learning API and viewing a difference between estimation results. That is, there is known a risk of a breach of information regarding confidential data used for learning by a machine learning model.

Here, let a learning data set be a set D^{p}={x^{p}ᵢ, y^{p}ᵢ|i∈I} of input data x^{p}ᵢ and output data y^{p}ᵢ that is paired with the input data x^{p}ᵢ. i is a subscript indicating a data number, and p is a subscript indicating that the learning data set is confidential. The output data y^{p}ᵢ indicates a ground truth label for the input data x^{p}ᵢ.

Furthermore, the machine learning model is represented by a function f in the following mathematical formula (1) that returns an estimate value of the output data yᵢ for the input data xᵢ.

yᵢ=f(xᵢ;w) (1)

w represents a parameter for the machine learning model.

Various functions can be applied to the function f, and for example, a function using a neural network is applied.

In learning by a machine learning model f, for example, a cross entropy loss is used for an error function, and a gradient method is executed on a sum of error functions related to all data samples of the learning data set, by which a parameter w is calculated.

Hereinafter, an action of inferring information regarding data, which is used for learning, from an estimate value returned by a machine learning model is referred to as an attack, and a user who performs the action is referred to as an attacker.

Here, for example, there is a case where the learning data set is updated and relearning is performed in order to improve estimation accuracy of the machine learning model. At this time, because the parameter w changes due to relearning, estimation results with respect to the same input data are different before and after the learning data set is updated. For example, there is a possibility that confidential data changed in the learning data set is identified on the basis of the difference between the estimation results.

For example, in a case where the function f is a machine learning model that returns an average annual income of a certain company, there is a possibility that an annual income of one employee who has left the company is identified on the basis of average annual incomes before and after the employee leaves the company and of the number of employees of the company before and after the employee leaves the company. For example, in the example in FIG. 1, there is a risk of identification of an annual income of an employee in his/her twenties with an annual income grade A.

Furthermore, even if the learning data set is not updated, data can be identified by operating an input query so as to output a characteristic attribute of one record in the learning data set as an estimation result.

For example, in a case where the function f is a model that returns an average annual income of a certain company for each category of years of employment, and only a person A alone belongs to a certain age category, an average annual income of the age category is equal to an annual income of the person A, and thus there is a possibility that the annual income of the person A is identified.

Meanwhile, for example, “M. Abadi, U. Erlingsson, I. Goodfellow, H. B. McMahan, I. Mironov, N. Papernot, K. Talwar, and L. Zhang, ‘On the Protection of Private Information in Machine Learning Systems: Two Recent Approaches,’ August 2017” (hereinafter, referred to as Non-Patent Document 1) provides a leakage risk evaluation method and a breach risk control method, the methods introducing a differential privacy mechanism into a machine learning model.

Specifically, there is a differential privacy index as an index for evaluating how robust the machine learning model is against a risk of leakage of confidential data. The differential privacy index is represented by a parameter (ε, δ) defined as follows.

First, let ε>0, δ∈[0, 1].

Furthermore, let D be a learning data set, and D′ be a data set in which only one datum in the learning data set D is changed. Note that, hereinafter, the learning data set D and the learning data set D′ are referred to as learning data sets adjacent to each other.

At this time, the following mathematical formula (2) holds for any adjacent learning data set D and learning data set D′, and a set A∈Z as any estimation result, when distribution ρ_{D} of results of estimation by the machine learning model satisfies differential privacy.

Pr_{z˜ρ(y)}=[z∈A]≤e^{ε}Pr_{z˜ρ(y)}[z∈A]+δ (2)

Note that y=f(x|D), y′=f(x|D′), and z is a sample of an estimation result generated by a probabilistic algorithm ρ.

Intuitively, satisfaction of differential privacy means difficulty in identification of data changed between a learning data set D and a learning data set D′ from estimation results, because there is little change in an estimation result with respect to a change in the learning data set. With this arrangement, the attacker cannot know from which data set, the learning data set D or the learning data set D′, the machine learning model has been learned, even if any previous knowledge is used.

The smaller both a parameter ε and a parameter δ are, the higher information confidentiality is. The parameter ε indicates that a change in probability distribution due to a change in the learning data set is at most e^{ε} times. Furthermore, the parameter δ indicates an allowable amount of change in the probability distribution by a constant.

As a theorem regarding a general parameter δ, it is known that satisfaction of (ε, δ)—differential privacy and satisfaction of (2ε)—differential privacy with a probability of 1-2δ/(e^{ε}ε) are equivalent. From this relation, the parameter δ is interpreted as a failure rate of the differential privacy. Furthermore, from this interpretation, it is generally recommended that the parameter δ be a value smaller than a reciprocal of the number of pieces of confidential data used at a time of learning.

Then, in order to achieve differential privacy, for example, some change is added without presenting a result of estimation by the machine learning model as is. Such a change is referred to as a differential privacy mechanism.

Examples of the differential privacy mechanism include, for example, a method for adding noise (for example, Laplace noise, Gaussian noise, or the like) to an estimation result. Furthermore, there are various variations of differential privacy mechanisms depending on a magnitude or type of the noise, other settings, and the like. Then, studies and proposals have been made on a method for securing strong differential privacy while maintaining estimation accuracy of a machine learning model.

In general, by repeating the same estimation processing many times, an average of estimation results converges to an expected value not affected by noise, and therefore differential privacy degrades and a risk of an information breach increases. Therefore, it is necessary to restrict the number of times of executing estimation processing.

Meanwhile, exceptionally, there is a method with which differential privacy can be secured even if estimation processing is infinitely repeated in exchange for degradation in estimation accuracy, by using a disclosable data set D^{o}={x^{o}ⱼ|j∈J} as a learning data set separately from a confidential data set D^{p}={x^{p}ᵢ, y^{p}ᵢ|i∈I} including confidential data. Such a method is described in, for example, “N. Papernot, S. Song, I. Mironov, A. Raghunathan, K. Talwar, and U. Erlingsson, ‘Scalable Private Learning with PATE,’ February 2018” (hereinafter, referred to as Non-Patent Document 2) and “R. Bassily, O. Thakkar, and A. Thakurta, ‘Model-Agnostic Private Learning via Stability,’ March 2018” (hereinafter, referred to as Non-Patent Document 3).

In this method, for example, a plurality of teacher models is internally generated by using confidential data, and finally, a student model is learned by using a disclosed data set and a majority vote of results of estimation by each of the teacher models with respect to the disclosed data set. Then, when an estimation label for the disclosed data set is output by the majority vote of a teacher model aggregation, specific noise is added, by which information confidentiality is secured.

Furthermore, at a time of operation, the student model is disclosed. Because the student model is generated by using the disclosed data set and the output label for which differential privacy is guaranteed, the differential privacy is not degraded no matter how many times estimation processing is executed.

In the present technology, as will be described later, a user interface (UI) for securing confidentiality of confidential data and preventing an information breach is provided by applying a differential privacy mechanism.

### Measures Against Adversarial Examples

Furthermore, in recent years, there has been reported presence of input data capable of greatly differentiating a result of estimation by a machine learning model with respect to a change that a human feels a minute change. For example, “N. Carlini and D. Wagner, ‘adversarial examples Are Not Easily Detected: Bypassing Ten Detection Methods,’ May 2017” (hereinafter, referred to as Non-Patent Document 4) proposes methods for creating input data that enables operation of a result of estimation conducted by a machine learning model so that the result is convenient for an attacker by abusing this.

As will be described later, the present technology provides a function of detecting an adversarial example and notifying that an attack has been performed, and a UI for improving robustness of a machine learning model so as to return a correct estimation result even if an adversarial example is input.

### 2. Embodiment

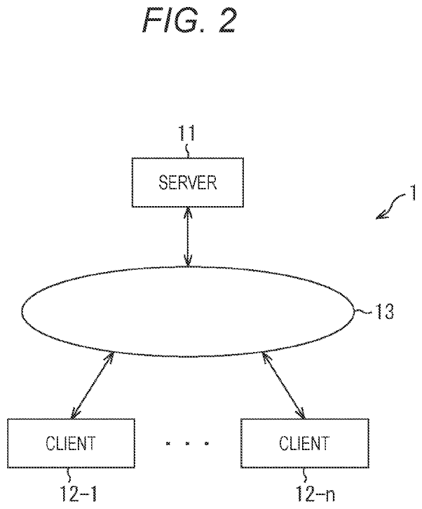

Next, an embodiment of the present technology will be described with reference to FIGS. 2 to 18.

<Configuration Example of Information Processing System 1>

FIG. 2 is a block diagram illustrating an embodiment of an information processing system 1 to which the present technology is applied.

The information processing system 1 includes a server 11 and clients 12-1 to 12-n. The server 11 and the clients 12-1 to 12-n are connected to each other via a network 13 and communicate with each other. Any communication method can be adopted as a method for communicating the server 11 and the clients 12-1 to 12-n, regardless of wired or wireless.

Note that, hereinafter, in a case where it is not necessary to individually distinguish the clients 12-1 to 12-n, the clients are simply referred to as a client 12.

The server 11 generates a machine learning model by machine learning according to a request from a certain client 12, and provides each client 12 with a service of providing another client 12 with the generated machine learning model or a machine learning API corresponding to the machine learning model.

Each client 12 includes, for example, a portable information terminal such as a smartphone, a tablet, a mobile phone, or a notebook personal computer, a desktop personal computer, or an information processing device such as a game machine.

<Configuration Example of Server 11>

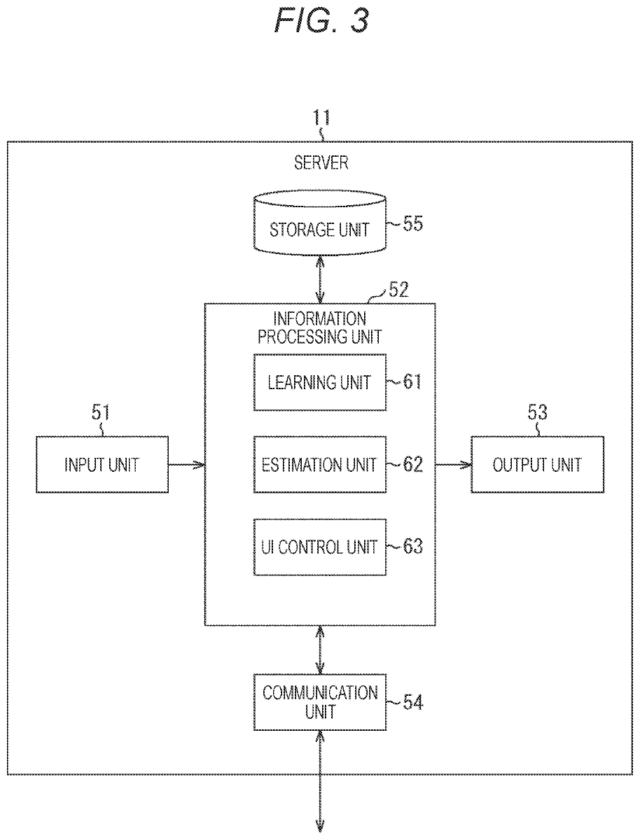

FIG. 3 illustrates a configuration example of the server 11.

The server 11 includes an input unit 51, an information processing unit 52, an output unit 53, a communication unit 54, and a storage unit 55.

The input unit 51 includes, for example, an input apparatus such as a switch, a button, a key, a microphone, or an image sensor, and is used to input various data or instructions. The input unit 51 supplies input data or an input instruction to the information processing unit 52.

The information processing unit 52 includes a learning unit 61, an estimation unit 62, and a user interface (UI) control unit 63.

The learning unit 61 performs learning by a learning model according to an instruction from the client 12 and generates a machine learning model. Furthermore, the learning unit 61 further generates a machine learning API for using the machine learning model, that is, an API that returns, to input data, a result of estimation by the machine learning model, as necessary. Furthermore, the learning unit 61 performs a security measure for the machine learning model and the machine learning API according to an instruction from the client 12. The learning unit 61 stores the generated machine learning model and machine learning API in the storage unit 55.

The estimation unit 62 performs processing of estimating a predetermined estimation target by inputting input data received from the client 12 to the machine learning model or the machine learning API via the network 13 and the communication unit 54. Furthermore, the estimation unit 62 detects an attack on the machine learning model or the machine learning API by performing processing of detecting an adversarial example, and stores history of the detected attack in the storage unit 55.

The UI control unit 63 controls each client 12 via the communication unit 54 and the network 13, thereby controlling a user interface such as a graphical user interface (GUI) in each client 12 for utilizing a service provided by the server 11. For example, the UI control unit 63 controls a user interface for performing a setting related to security for the machine learning model in the client 12. Furthermore, the UI control unit 63 controls a user interface such as a GUI by the output unit 53.

The output unit 53 includes, for example, an output apparatus such as a display, a speaker, a lighting device, or a vibrator, and outputs various data by using image, sound, light, vibration, or the like.

The communication unit 54 includes, for example, a communication apparatus or the like, and communicates with each client 12 via the network 13. Note that a communication method by the communication unit 54 is not particularly limited, and may be either a wired or wireless communication method. Furthermore, for example, the communication unit 54 may support a plurality of communication methods.

The storage unit 55 includes at least a non-volatile storage medium, and stores various data or software necessary for processing of the server 11. For example, the storage unit 55 stores a machine learning model, a machine learning API, a learning data set, data regarding a user of a service provided by the server 11, history of an attack from each client 12, or the like.

<Learning Processing>

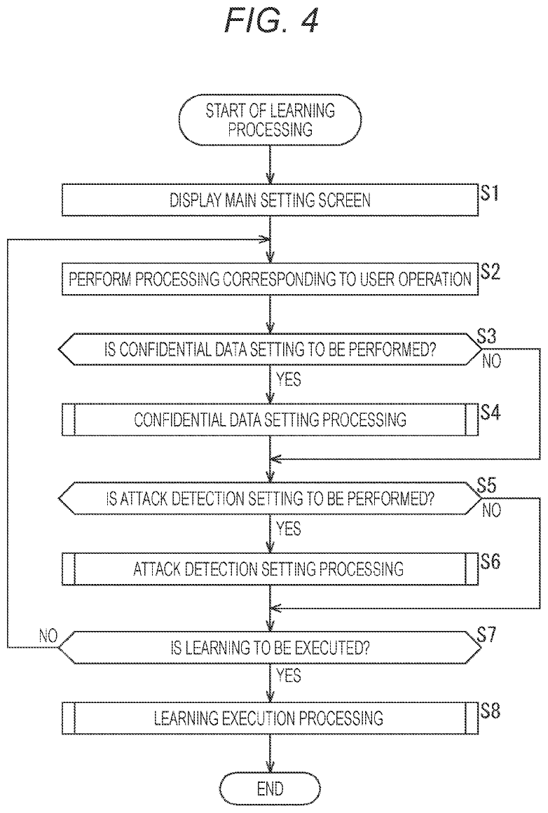

Next, learning processing executed by the information processing system 1 will be described with reference to the flowchart in FIG. 4.

This processing is started, for example, when a user (hereinafter, referred to as a model creator) inputs an instruction to execute a machine learning model learning processing to the client 12.

Note that, hereinafter, unless otherwise specified, the client 12 refers to a client 12 used by the model creator in this processing.

In Step S1, the client 12 displays a main setting screen.

Specifically, the client 12 transmits, to the server 11 via the network 13, information indicating an instruction to execute the learning processing input by the model creator.

Meanwhile, the UI control unit 63 of the server 11 receives information indicating the instruction from the model creator via the communication unit 54. Then, the UI control unit 63 controls the client 12 via the communication unit 54 and the network 13 to display the main setting screen.

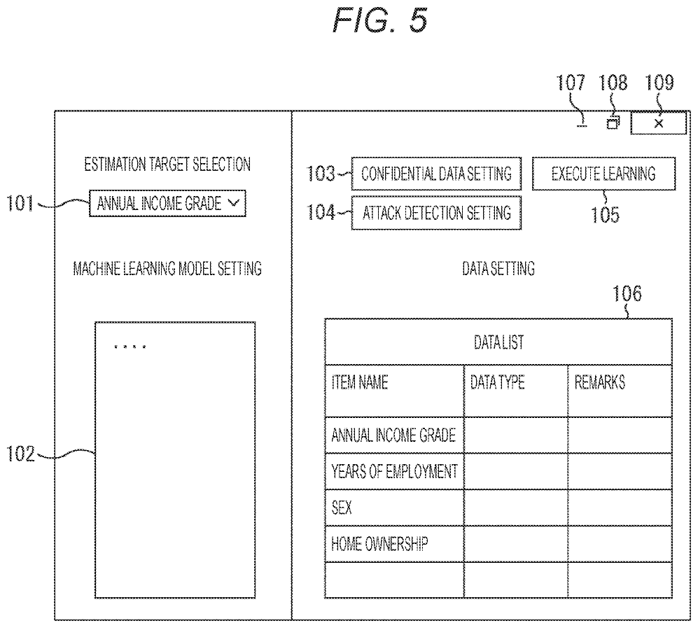

FIG. 5 illustrates an example of the main setting screen. The main setting screen includes a pull-down menu 101, a machine learning model setting area 102, a confidential data setting button 103, an attack detection setting button 104, a learning execution button 105, a data setting area 106, a minimization button 107, an enlarge/reduce button 108, and a close button 109.

The pull-down menu 101 is used to select an item to be estimated by the machine learning model from among items of data that are set in the data setting area 106.

The machine learning model setting area 102 is used for various settings (for example, setting for a learning method, a model type, or the like) related to the machine learning model, display of setting content, or the like.

The confidential data setting button 103 is used to instruct execution of a confidential data setting to be described later.

The attack detection setting button 104 is used to instruct execution of an attack detection setting to be described later.

The learning execution button 105 is used to instruct execution of learning by the machine learning model.

The data setting area 106 is used to set input data or output data of a learning data set of the machine learning model, display setting content, or the like. For example, a setting or display of an item name, data type, description, or the like of each data included in the input data or the output data is performed.

The minimization button 107 is used to minimize the main setting screen.

The enlarge/reduce button 108 is used to display the main setting screen in full screen or in reduced screen.

The close button 109 is used to close the main setting screen.

Note that the minimization button 107, the enlarge/reduce button 108, and the close button 109 are similarly displayed on other screens described later. Hereinafter, illustration of reference signs of the minimization button 107, the enlarge/reduce button 108, and the close button 109, and description thereof will be omitted.

In Step S2, the information processing system 1 performs processing corresponding to user operation. For example, the model creator performs various operations on the main setting screen displayed on the client 12. The client 12 transmits information indicating operation content to the server 11 via the network 13. The server 11 performs processing corresponding to operation by the model creator. Furthermore, the UI control unit 63 controls display of a screen of the client 12, or the like, via the communication unit 54 and the network 13, as necessary.

In Step S3, the UI control unit 63 determines whether or not to perform a confidential data setting. In a case where it is detected that the confidential data setting button 103 on the main setting screen has been pressed in the client 12, the UI control unit 63 determines that the confidential data setting is to be performed, and the processing proceeds to Step S4.

In Step S4, the server 11 performs the confidential data setting processing, and the processing proceeds to Step S5.

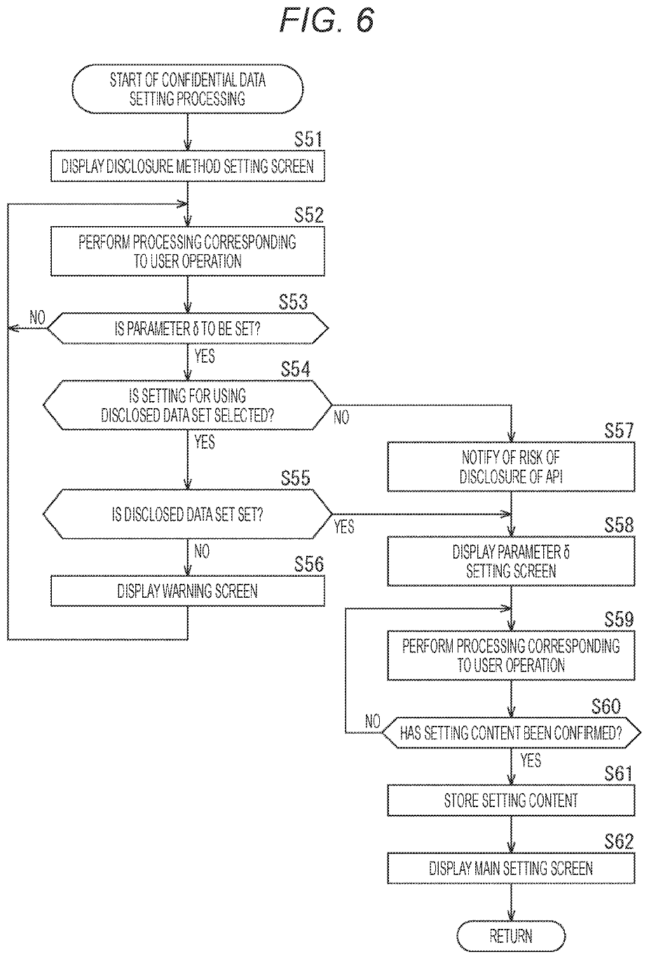

Here, details of the confidential data setting processing will be described with reference to the flowchart in FIG. 6.

In Step S51, under control of the communication unit 54 and the UI control unit 63 via the network, the client 12 displays a disclosure method setting screen.

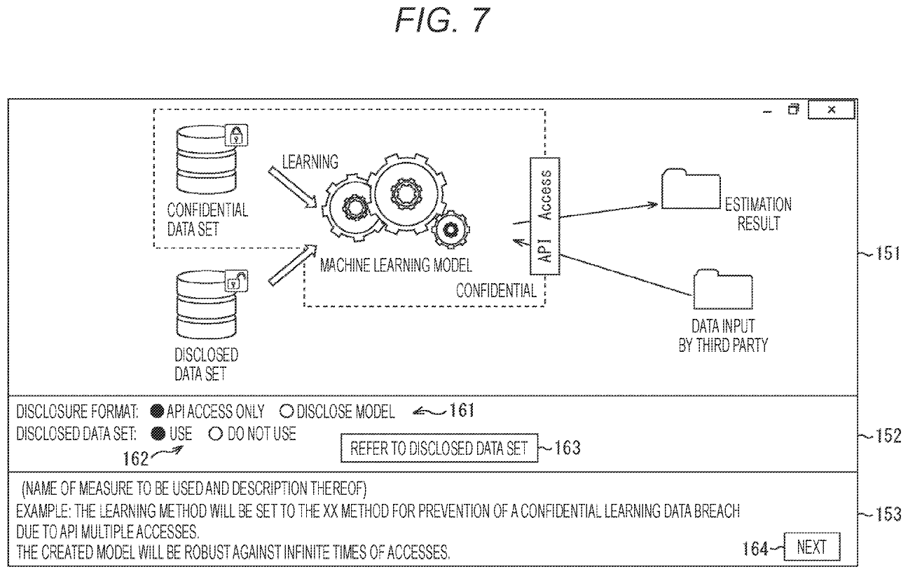

FIG. 7 illustrates an example of the disclosure method setting screen.

The disclosure method setting screen includes a system display area 151, a setting area 152, and a description area 153.

The system display area 151 displays a system configuration diagram illustrating setting content of a current machine learning model disclosure method. In this example, it is illustrated that learning by the machine learning model is performed by using a confidential data set and a disclosed data set, a machine learning API is set to be disclosed, and the machine learning model and the confidential data set are concealed. Furthermore, it is illustrated that an estimation result is returned when a third party inputs input data to the machine learning API.

The setting area 152 displays radio buttons 161, radio buttons 162, and a reference button 163 for setting a machine learning model disclosure method.

The radio buttons 161 are used to set a disclosure format. In a case where it is desired to disclose only a machine learning API, an item “API access only” is selected, and in a case where it is desired to disclose the machine learning model, an item “disclose model” is selected.

The radio buttons 162 are used to set whether or not to use a disclosed data set. Specifically, in a case where the item “API access only” is selected in the radio buttons 161 and the machine learning API is to be disclosed, the radio buttons 162 are enabled, and whether or not to use a disclosed data set can be set. Then, in a case where a disclosed data set is used for learning by the machine learning model, an item “use” is selected, and in a case where a disclosed data set is not used for learning by the machine learning model, an item “do not use” is selected.

Meanwhile, in a case where the item “disclose model” is selected in the radio buttons 161 and the machine learning model is to be disclosed, a setting for the radio buttons 162 is fixed to “use”, and a setting for whether or not to use a disclosed data set is disabled. That is, in order to secure differential privacy, in a case where the machine learning model is to be disclosed, only a learning method using a disclosed data set can be selected.

The reference button 163 can be pressed in a case where the item “use” in the radio buttons 162 is selected. Then, when the reference button 163 is pressed, a menu screen for selecting (a file including) the disclosed data set is displayed, and a disclosed data set to be used can be selected.

Note that the disclosed data set may not have a ground truth label corresponding to an estimation result due to a characteristic of the method.

The description area 153 displays description text of a learning method corresponding to current setting content. That is, a name of a measure (learning method) to be used to protect confidential data and description thereof are displayed. Furthermore, a transition button 164 for transitioning to a next screen is displayed.

Returning to FIG. 6, in Step S52, the server 11 performs processing corresponding to user operation. For example, the model creator performs various operations on the disclosure method setting screen displayed on the client 12. The client 12 transmits information indicating operation content to the server 11 via the network 13. The server 11 performs processing corresponding to operation by the model creator. Furthermore, the UI control unit 63 controls display of a screen of the client 12, or the like, via the communication unit 54 and the network 13, as necessary.

In Step S53, the UI control unit 63 determines whether or not to set a parameter δ. In a case where it is not detected that the transition button 164 in the disclosure method setting screen has been pressed in the client 12, the UI control unit 63 determines that the parameter δ is not to be set, and the processing returns to Step S52.

Thereafter, processing in Steps S52 and S53 is repeatedly executed until it is determined in Step S53 that the parameter δ is to be set.

Meanwhile, in Step S53, in a case where it is detected that the transition button 164 in the disclosure method setting screen has been pressed in the client 12, the UI control unit 63 determines that the parameter δ is to be set, and the processing proceeds to Step S54.

In Step S54, the UI control unit 63 determines whether or not a setting for using a disclosed data set is selected. In a case where the item “use” in the radio buttons 162 in the disclosure method setting screen is selected, the UI control unit 63 determines that the setting for using a disclosed data set is selected, and the processing proceeds to Step S55.

In Step S55, the UI control unit 63 determines whether or not a disclosed data set is set. In a case where a file including the disclosed data set has not been selected, the UI control unit 63 determines that the disclosed data set is not set, and the processing proceeds to Step S56.

In Step S56, under control of the communication unit 54 and the UI control unit 63 via the network, the client 12 displays a warning screen. For example, a warning screen for prompting the model creator to set the disclosed data set is displayed.

Thereafter, the processing returns to Step S52, and the processing in Steps S52 to S56 is repeatedly executed until it is determined in Step S54 that the setting for using a disclosed data set is not selected, or until it is determined in Step S55 that the disclosed data set is set.

Meanwhile, in Step S54, in a case where the item “do not use” in the radio buttons 162 in the disclosure method setting screen is selected, the UI control unit 63 determines that the setting for using a disclosed data set is not selected, and the processing proceeds to Step S57.

In Step S57, under control of the communication unit 54 and the UI control unit 63 via the network, the client 12 notifies of a risk of disclosure of an API. For example, if a machine learning API corresponding to a machine learning model that learned without using a disclosed data set is disclosed, confidentiality of confidential data used for the learning cannot be guaranteed unless the number of accesses of the machine learning API (hereinafter referred to as the number of API accesses) is restricted, and a warning screen for notifying that there is a risk of an information breach is displayed.

Thereafter, the processing proceeds to Step S58.

Meanwhile, in Step S55, in a case where a file including the disclosed data set has been selected, the UI control unit 63 determines that the disclosed data set is set, and the processing proceeds to Step S58.

In Step S58, under control of the communication unit 54 and the UI control unit 63 via the network, the client 12 displays a parameter δ setting screen.

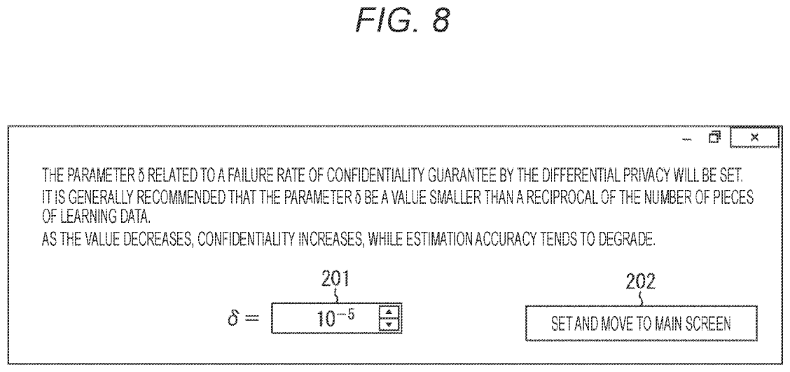

FIG. 8 illustrates an example of a parameter δ setting screen. The parameter δ setting screen includes an input field 201 and a setting button 202.

The input field 201 is used to input a value of a parameter δ.

The setting button 202 is used to confirm the setting content of the disclosure method and to transition to the main setting screen.

Furthermore, the setting screen displays description regarding the parameter δ. That is, it is indicated that the parameter δ is a parameter related to a failure rate of confidentiality guarantee by the differential privacy, that a value smaller than a reciprocal of the number of pieces of learning data is a recommended value, and that as the value decreases, confidentiality increases, while estimation accuracy of the machine learning model tends to degrade.

In Step S59, the information processing system 1 performs processing corresponding to user operation. For example, the model creator performs various operations on the parameter δ setting screen displayed on the client 12. The client 12 transmits information indicating operation content to the server 11 via the network 13. The server 11 performs processing corresponding to operation by the model creator. Furthermore, the UI control unit 63 controls display of a screen of the client 12, or the like, via the communication unit 54 and the network 13, as necessary.

In Step S60, the UI control unit 63 determines whether or not the setting content has been confirmed. In a case where it is not detected that the setting button 202 in the parameter δ setting screen has been pressed in the client 12, the UI control unit 63 determines that the setting content is not confirmed, and the processing returns to Step S59.

Thereafter, processing in Steps S59 and S60 is repeatedly executed until it is determined in Step S60 that the setting content has been confirmed.

Meanwhile, in Step S60, in a case where it is detected that the setting button 202 in the parameter δ setting screen has been pressed in the client 12, the UI control unit 63 determines that the setting content has been confirmed, and the processing proceeds to Step S61.

In Step S61, the server 11 stores the setting content. For example, in the storage unit 55, the UI control unit 63 stores a disclosure format of the machine learning model, whether or not to use the disclosed data set, the disclosed data set (in a case where the disclosed data set is used), and the parameter δ in association with one another.

In Step S62, a main setting screen is displayed similarly to the processing in Step S1 in FIG. 4.

Returning to FIG. 4, meanwhile, in Step S3, in a case where it is not detected that the confidential data setting button 103 on the main setting screen has been pressed in the client 12, the UI control unit 63 determines that the confidential data setting is not to be performed, and the processing proceeds to Step S5, skipping the processing in Step S4.

In Step S5, the UI control unit 63 determines whether or not to perform an attack detection setting. In a case where it is detected that the attack detection setting button 104 on the main setting screen has been pressed in the client 12, the UI control unit 63 determines that the attack detection setting is to be performed, and the processing proceeds to Step S6.

In Step S6, the server 11 performs the attack detection setting processing, and the processing proceeds to Step S7.

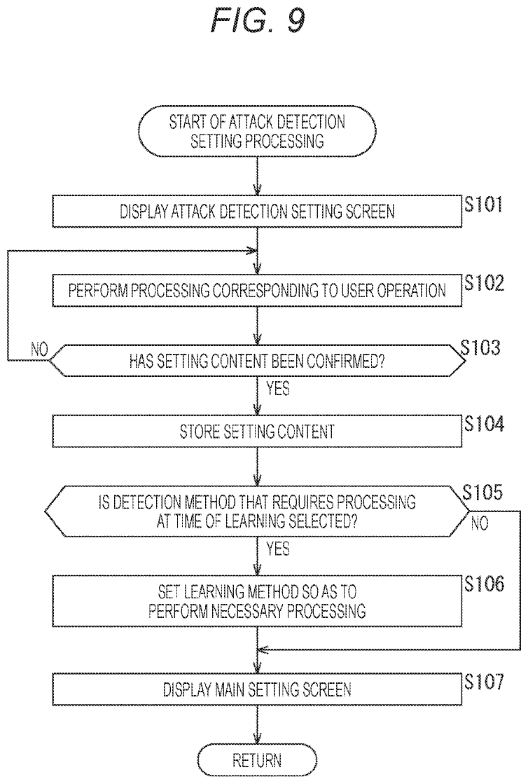

Here, details of the attack detection setting processing will be described with reference to the flowchart in FIG. 9.

In Step S101, under control of the communication unit 54 and the UI control unit 63 via the network, the client 12 displays an attack detection setting screen.

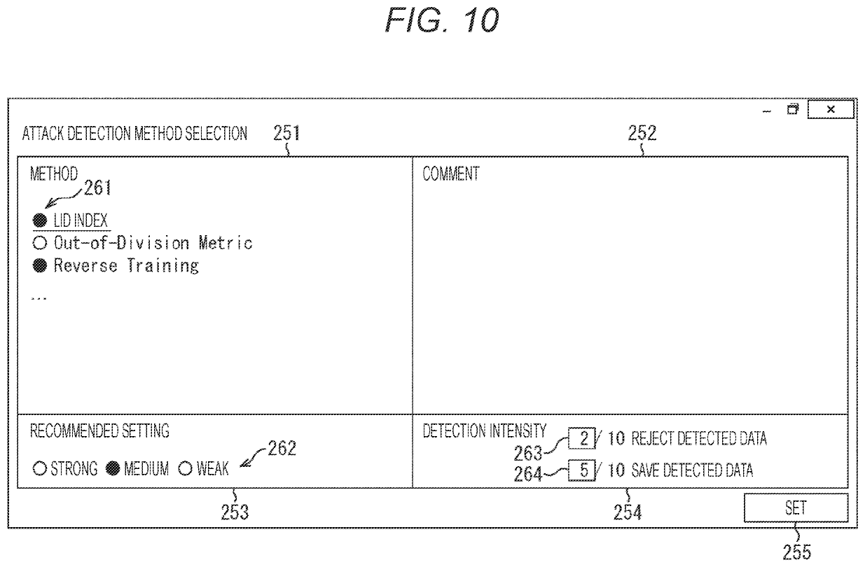

FIG. 10 illustrates an example of the attack detection setting screen.

The attack detection setting screen includes an attack detection method selection area 251, a comment area 252, a recommended setting area 253, a detection intensity setting area 254, and a set button 255.

The attack detection method selection area 251 is an area for selecting a method to be applied to detection of an adversarial example. For example, detection methods that the server 11 can support are listed along with check boxes 261. The model creator can select a desired detection method from among the presented detection methods by operating the check boxes 261. At this time, the model creator can select a plurality of detection methods.

Note that examples of methods for detecting an adversarial example include methods described in “X. Ma, B. Li, Y. Wang, S. M. Erfani, S. Wijewickrema, G. Schoenebeck, D. Song, M. E. Houle, and J. Bailey, ‘Characterizing Adversarial Subspaces Using Local Intrinsic Dimensionality,’ January 2018” (hereinafter, referred to as Non-Patent Document 5), “T. Pang, C. Du, Y. Dong, and J. Zhu, ‘Towards Robust Detection of adversarial examples,’ June 2017” (hereinafter, referred to as Non-Patent Document 6), and “K. Lee, K. Lee, H. Lee, and J. Shin, ‘A Simple Unified Framework for Detecting Out-of-Distribution Samples and Adversarial Attacks,’ July 2018” (hereinafter, referred to as Non-Patent Document 7), and the like.

The comment area 252 displays brief description of a method selected from the detection methods displayed in the attack detection method selection area 251.

The recommended setting area 253 displays radio buttons 262. In this example, for example, combinations of detection methods at three levels, “strong”, “medium”, and “weak”, recommended by the server 11 is prepared in advance. The model creator can easily select any one of the combinations of the detection methods at three levels, “strong”, “medium”, and “weak”, by operating the radio buttons 262.

The detection intensity setting area 254 is an area for setting intensity of detecting an adversarial example.

The model creator can set intensity of rejecting input data by inputting a desired numerical value (hereinafter, referred to as a rejection threshold value) in an input field 263. For example, in a case where the rejection threshold value is set to 2, when input data is detected as an adversarial example by two or more kinds of detection methods, the input data is rejected, and estimation processing is stopped.

Furthermore, the model creator can set intensity of saving input data by inputting a desired numerical value (hereinafter, referred to as a saving threshold value) in an input field 264. For example, in a case where the saving threshold value is set to 5, when input data is detected as an adversarial example by five or more kinds of detection methods, the input data is saved in the storage unit 55. Then, for example, by using the saved input data for learning processing, an attack using the input data and similar input data as adversarial examples can be prevented.

Note that, for example, the rejection threshold value is restricted to a value equal to or less than the saving threshold value.

The set button 255 is used to confirm setting content of attack detection.

In Step S102, the information processing system 1 performs processing corresponding to user operation. For example, the model creator performs various operations on the attack detection setting screen displayed on the client 12. The client 12 transmits information indicating operation content to the server 11 via the network 13. The server 11 performs processing corresponding to operation by the model creator. Furthermore, the UI control unit 63 controls display of a screen of the client 12, or the like, via the communication unit 54 and the network 13, as necessary.

In Step S103, the UI control unit 63 determines whether or not the setting content has been confirmed. In a case where it is not detected that the set button 255 in the attack detection setting screen has been pressed in the client 12, the UI control unit 63 determines that the setting content is not confirmed, and the processing returns to Step S102.

Thereafter, processing in Steps S102 and S103 is repeatedly executed until it is determined in Step S103 that the setting content has been confirmed.

Meanwhile, in Step S103, in a case where it is detected that the set button 255 in the attack detection setting screen has been pressed in the client 12, the UI control unit 63 determines that the setting content has been confirmed, and the processing proceeds to Step S104.

In Step S104, the UI control unit 63 stores the setting content. For example, in the storage unit 55, the UI control unit 63 stores the method for detecting an adversarial example to be used and the detection intensity (rejection threshold value and saving threshold value) in association with each other.

In Step S105, the learning unit 61 determines whether or not a detection method that requires processing at a time of learning is selected.

For example, the detection method in the above-described Non-Patent Document 6 is a method capable of constructing a system that detects an adversarial example by analyzing a machine learning model as post-processing after learning by the machine learning model. Meanwhile, in the detection methods in the above-described Non-Patent Document 5 and Non-Patent Document 7, it is necessary to perform predetermined processing at a time of learning by a machine learning model in order to detect an adversarial example.

For example, as in the detection methods in Non-Patent Document 5 and Non-Patent Document 7, in a case where it is determined that a detection method that requires performance of predetermined processing at a time of learning by the machine learning model is selected, the processing proceeds to Step S106.

In Step S106, the learning unit 61 sets a learning method so as to perform necessary processing. That is, the learning unit 61 performs setting so as to perform processing corresponding to the selected detection method at the time of learning by the machine learning model.

Thereafter, the processing proceeds to Step S107.

Meanwhile, in a case where it is determined in Step S105 that the detection method that requires processing at the time of learning is not selected, the processing proceeds to Step S107, skipping the processing in Step S106.

In Step S107, a main setting screen is displayed similarly to the processing in Step S1 in FIG. 4.

Thereafter, the attack detection setting processing ends.

Returning to FIG. 4, meanwhile, in Step S5, in a case where it is not detected that the attack detection setting button 104 on the main setting screen has been pressed in the client 12, the UI control unit 63 determines that the attack detection setting is not to be performed, and the processing proceeds to Step S7, skipping the processing in Step S6.

In Step S7, the UI control unit 63 determines whether or not to execute learning. In a case where it is not detected that the learning execution button 105 in the main setting screen has been pressed in the client 12, the UI control unit 63 determines that the learning is not to be executed, and the processing returns to Step S2.

Thereafter, processing in Steps S2 to S7 is repeatedly executed until it is determined in Step S7 that the learning is to be executed.

Meanwhile, in Step S7, in a case where it is detected that the learning execution button 105 in the main setting screen has been pressed in the client 12, the UI control unit 63 determines that the learning is to be executed, and the processing proceeds to Step S8.

In Step S8, the server 11 performs learning execution processing, and the learning processing ends.

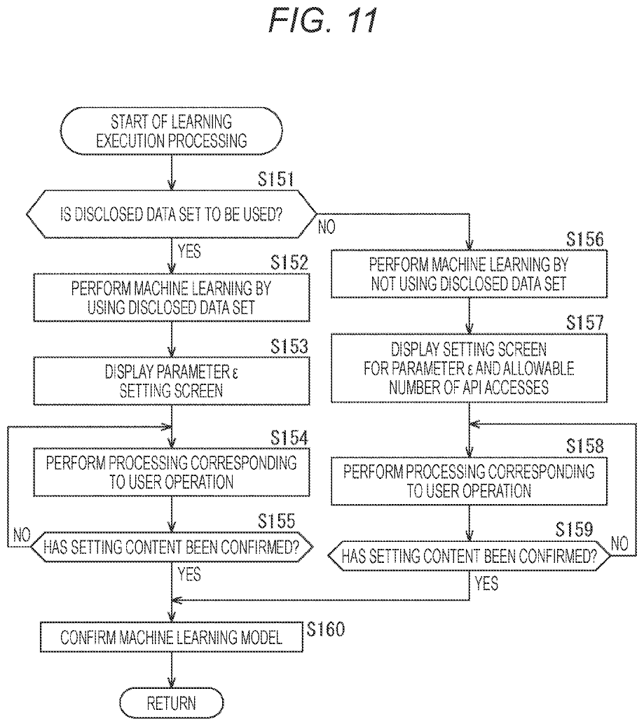

Here, details of the learning execution processing will be described with reference to the flowchart in FIG. 11.

In Step S151, the learning unit 61 determines whether or not a disclosed data set is to be used. In a case where a setting for using a disclosed data set is performed in the disclosure method setting screen in FIG. 7 described above, the learning unit 61 determines that the disclosed data set is to be used, and the processing proceeds to Step S152.

In Step S152, the learning unit 61 performs machine learning by using the disclosed data set. That is, the learning unit 61 performs machine learning by using the disclosed data set according to content set in the setting screens illustrated in FIGS. 5, 7, 8, and 10, and generates a machine learning model corresponding to the set content. Furthermore, the learning unit 61 performs the machine learning a plurality of times while changing a parameter ε within the number of times or period set by the model creator. With this arrangement, a plurality of machine learning models having different parameters e is generated.

In Step S153, under control of the communication unit 54 and the UI control unit 63 via the network, the client 12 displays a parameter ε setting screen.

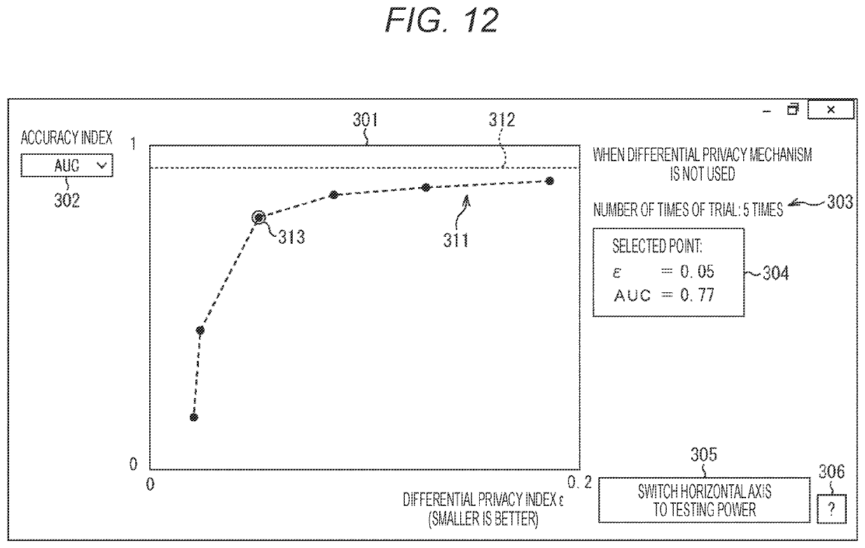

FIG. 12 illustrates an example of a parameter ε setting screen.

The parameter z setting screen includes a parameter setting area 301, a pull-down menu 302, a trial number display area 303, a setting value display area 304, a switch button 305, and a help button 306.

The parameter setting area 301 is an area for setting a parameter ε. The horizontal axis of the parameter setting area 301 indicates the parameter ε (differential privacy index c), and the vertical axis indicates estimation accuracy of the machine learning model for the parameter ε.

Note that the index on the vertical axis representing the estimation accuracy can be changed by using the pull-down menu 302. In this diagram, an example is illustrated in which an area under curve (AUC) is set as an index representing the estimation accuracy.

The parameter setting area 301 displays a graph 311 illustrating a characteristic of estimation accuracy of a machine learning model with respect to the parameter ε. The graph 311 is displayed on the basis of a result of performing machine learning a plurality of times while changing the parameter ε. Furthermore, an auxiliary line 312 indicating estimation accuracy of when the differential privacy mechanism is not used is displayed.

Here, in a case where the differential privacy mechanism is used, estimation accuracy decreases as compared to a case where the differential privacy mechanism is not used. Furthermore, the smaller the value of the parameter ε, the higher information confidentiality (for example, a degree of guarantee for confidentiality), while the lower the estimation accuracy. Conversely, the larger the value of the parameter ε, the lower information confidentiality, while the higher the estimation accuracy.

The model creator can set a parameter ε by selecting any one of a plurality of points on the graph 311 with a circular pointer 313. The parameter ε corresponding to the selected point and the value of the estimation accuracy are displayed in the setting value display area 304.

The trial number display area 303 displays the number of times of trial of machine learning. The number of times of trial by machine learning can be changed. Note that, as the number of times of trial increases, the graph 311 becomes smoother, and the number of options of the parameter ε increases, while learning time increases. Conversely, as the number of times of trial decreases, the graph 311 becomes rougher, and the number of options of the parameter ε decreases, while learning time decreases.

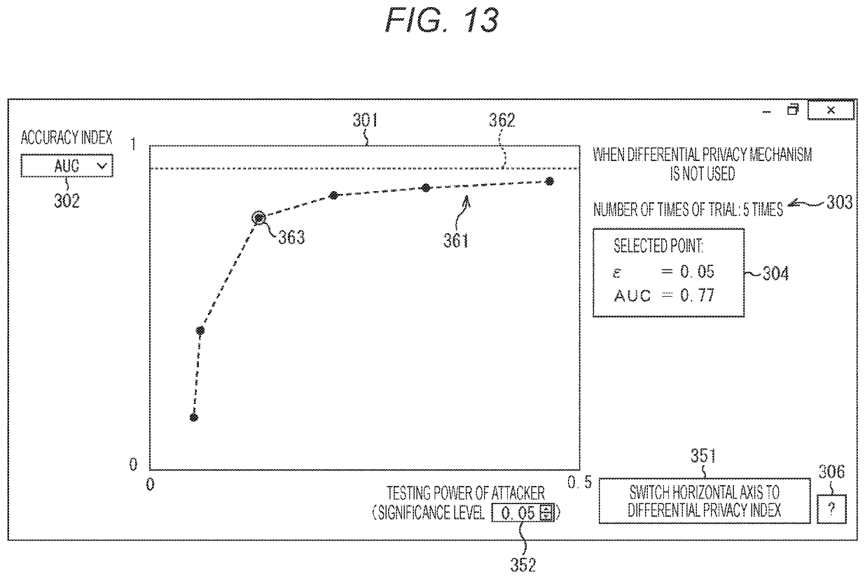

The switch button 305 is used to switch the horizontal axis of the parameter setting area 301. Then, when the switch button 305 is pressed, the parameter ε setting screen is switched to the screen illustrated in FIG. 13.

Note that, in the setting screen in FIG. 13, the parts corresponding to the parts in the setting screen in FIG. 12 are provided with the same reference signs, and description of the corresponding parts will be omitted as appropriate.

The setting screen in FIG. 13 is identical to the setting screen in FIG. 12 in including the parameter setting area 301, the pull-down menu 302, the trial number display area 303, the setting value display area 304, and the help button 306, and is different from the setting screen in FIG. 12 in including a switch button 351 instead of the switch button 305 and in newly displaying an input field 352. Furthermore, the horizontal axis of the parameter setting area 301 is changed from the parameter ε to testing power of an attacker.

It is assumed that it is difficult for many model creators to know how much information is concealed by the parameter ε and the parameter δ, which are indices of differential privacy.

Meanwhile, for example, “R. Hall, A. Rinaldo, and L. Wasserman, ‘Differential Privacy for Functions and Functional Data,’ 2012” (hereinafter, referred to as Non-Patent Document 8) describes that the following relation is established between an upper limit of detection power in a statistical hypothesis testing and the parameters ε and δ.

That is, it is described that if differential privacy (ε, δ) is satisfied, it is not possible to create a test having detection power of αe^{ε}+δ or more in a test at a significance level of α.

Accordingly, according to this relation, the parameter ε is converted into testing power on the basis of the parameter δ and a significance level of the testing power input in the input field 352. Note that the testing power changes by changing a value of the significance level in the input field 352.

The parameter setting area 301 displays a graph 361 illustrating a characteristic of estimation accuracy of a machine learning model with respect to the testing power of the attacker. Furthermore, an auxiliary line 362 indicating estimation accuracy of when the differential privacy mechanism is not used is displayed.

The model creator can set a desired parameter ε by selecting any one of a plurality of points on the graph 361 with a circular pointer 363. The parameter ε corresponding to the selected point and the value of the estimation accuracy are displayed in the setting value display area 304.

When the switch button 351 is pressed, the screen returns to the setting screen in FIG. 12.

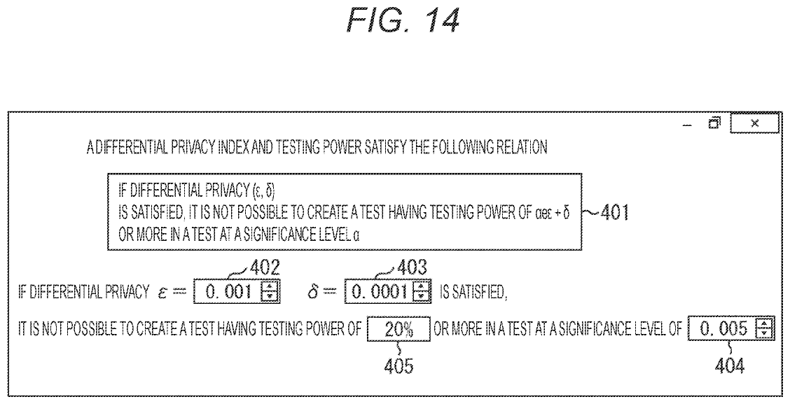

Furthermore, when the help button 306 is pressed in the setting screen in FIG. 12 or 13, the help screen in FIG. 14 is displayed.

The help screen is a screen for describing a relation between the parameter ε and the parameter δ, which are differential privacy indices, and testing power.

The help screen includes a comment area 401, input fields 402 to 404, and a display field 405.

The comment area 401 displays description related to a relation between the parameters e and parameter δ, and the testing power. That is, it is displayed that if differential privacy (ε, δ) is satisfied, it is not possible to create a test having detection power of αe^{ε}+δ or more in a test at a significance level of α.

The input fields 402 to 404 are used to input the parameter ε, the parameter δ, and the significance level, respectively. Then, the testing power is calculated on the basis of the parameter ε, parameter δ, and significance level input to the input fields 402 to 404 and displayed in the display field 405.

With this arrangement, the model creator can easily understand how the testing power changes with respect to the parameter ε, the parameter δ, and the significance level α of the test.

Returning to FIG. 11, in Step S154, the information processing system 1 performs processing corresponding to user operation. For example, the model creator performs various operations on the screens in FIGS. 12 to 14 displayed on the client 12. The client 12 transmits information indicating operation content to the server 11 via the network 13. The server 11 performs processing corresponding to operation by the model creator. Furthermore, the UI control unit 63 controls display of a screen of the client 12, or the like, via the communication unit 54 and the network 13, as necessary.

In Step S155, the UI control unit 63 determines whether or not the setting content has been confirmed. In a case where it is not detected that operation of confirming a setting for the parameter ε has been performed in the client 12, the UI control unit 63 determines that the setting content is not confirmed, and the processing returns to Step S154.

Thereafter, processing in Steps S154 and S155 is repeatedly executed until it is determined in Step S155 that the setting content has been confirmed.

Meanwhile, in Step S155, in a case where it is detected that operation of confirming a setting for the parameter ε has been performed in the client 12, the UI control unit 63 determines that the setting content has been confirmed, and the processing proceeds to Step S160.

Meanwhile, in a case where it is determined in step S151 that a disclosed data set is not to be used, the processing proceeds to step S156.

In Step S156, the learning unit 61 performs machine learning by not using the disclosed data set. That is, the learning unit 61 performs machine learning by not using the disclosed data set according to content set in the setting screens illustrated in FIGS. 5, 7, 8, and 10, and generates a machine learning model corresponding to the set content. Furthermore, the learning unit 61 performs the machine learning a plurality of times while changing a parameter ε within the number of times or period set by the model creator. With this arrangement, a plurality of machine learning models having different parameters ε is generated.

Note that, in a case where the disclosed data set is not used, for example, confidentiality of the confidential data is guaranteed by restricting an upper limit value of the number of API accesses (hereinafter, it is referred to as the allowable number of API accesses). That is, the confidentiality of the confidential data is guaranteed by restricting the number of times the same user inputs input data to the same machine learning API to cause estimation processing to be executed.

Furthermore, in the differential privacy mechanism that guarantees confidentiality of confidential data by the number of API accesses, differential privacy is achieved by adding noise to an estimation result in a post-processing manner. Therefore, because a calculation cost for evaluating estimation accuracy is low as compared to learning processing using a disclosed data set, it is possible to calculate estimation accuracy with respect to the parameter ε more times.

In Step S157, under control of the communication unit 54 and the UI control unit 63 via the network, the client 12 displays a setting screen for the parameter z and the allowable number of API accesses.

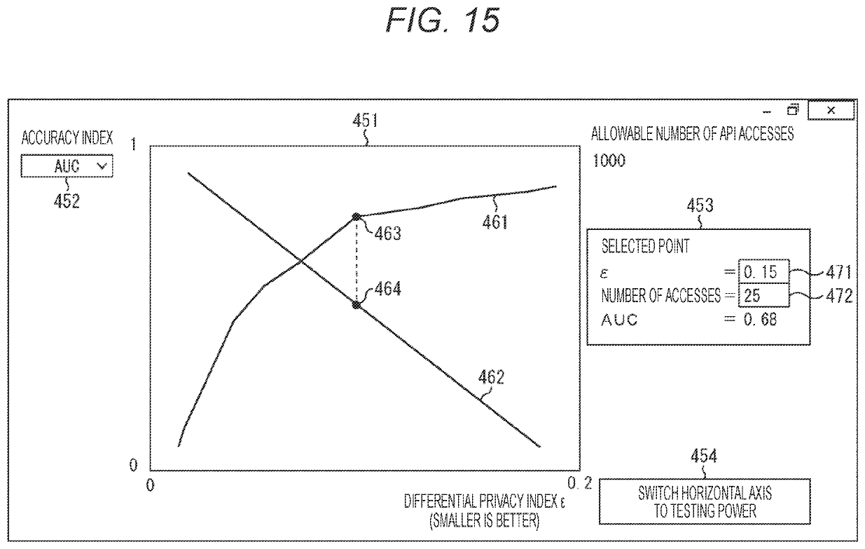

FIG. 15 illustrates an example of a setting screen of the setting screen for the parameter ε and the allowable number of API accesses.

The setting screen includes a characteristic display area 451, a pull-down menu 452, a setting area 453, and a switch button 454.

The characteristic display area 451 is an area for displaying characteristics of estimation accuracy and information confidentiality (for example, a degree of guarantee for confidentiality) of the machine learning model. The horizontal axis of the characteristic display area 451 indicates the parameter ε and the information confidentiality, and the vertical axis indicates estimation accuracy and the allowable number of API accesses.

The characteristic display area 451 displays a graph 461 illustrating a characteristic of estimation accuracy of the machine learning model with respect to the parameter c and a graph 462 illustrating a characteristic of information confidentiality with respect to the allowable number of API accesses.

The graph 461 is substantially similar to the graph 311 in FIG. 12.

However, as described above, in the differential privacy mechanism that guarantees confidentiality of confidential data with the number of API accesses, it is possible to calculate estimation accuracy with respect to the parameter F more time than learning processing using a disclosed data set. Therefore, the graph 461 can be smoothed as compared to the graph 311 in FIG. 12 and the graph 361 in FIG. 13, and the parameter z can be set from more options.

The graph 462 indicates that there is a trade-off between the allowable number of API accesses and information confidentiality. That is, depending on an adopted differential privacy mechanism, the allowable number of API accesses and degradation of information confidentiality are basically in a proportional relation. That is, as the allowable number of API accesses increases, the confidentiality of the confidential data decreases, and as the allowable number of API accesses decreases, the confidentiality of the confidential data improves.

Note that, before the setting screen in FIG. 15 is displayed, for example, a screen for describing that there is a trade-off between the allowable number of API accesses and information confidentiality may be displayed.

The setting area 453 displays an input field 471 and an input field 472. The input field 471 is used to input a value of a parameter F. The input field 472 is used to input the allowable number of API accesses.

When the parameter ε is input to the input field 471, a point 463 on the graph 461 moves to a position corresponding to the input parameter ε. Furthermore, a point 464 on the graph 462 moves to the same position in the horizontal axis direction as the point 463 after the movement. Furthermore, the allowable number of API accesses in the input field 472 changes to a value corresponding to the position of the point 464 after the movement.

Meanwhile, when the allowable number of API accesses is input to the input field 472, the point 464 on the graph 462 moves to a position corresponding to the allowable number of API accesses. Furthermore, the point 463 on the graph 461 moves to the same position in the horizontal axis direction as the point 464 after the movement. Moreover, the parameter ε in the input field 471 changes to a value corresponding to the position of the point 463 after the movement.

In this way, by changing either the parameter ε or the allowable number of API accesses, another changes to a corresponding value.

The switch button 454 is used to switch the horizontal axis of the characteristic display area 451. That is, although illustration is omitted, when the switch button 454 is pressed, the horizontal axis of the characteristic display area 451 changes to testing power of an attacker as in the setting screen in FIG. 13 described above.

Returning to FIG. 11, in Step S158, the information processing system 1 performs processing corresponding to user operation. For example, the model creator performs various operations on the screen in FIG. 15, or the like, displayed on the client 12. The client 12 transmits information indicating operation content to the server 11 via the network 13. The server 11 performs processing corresponding to operation by the model creator. Furthermore, the UI control unit 63 controls display of a screen of the client 12, or the like, via the communication unit 54 and the network 13, as necessary.

In Step S159, the UI control unit 63 determines whether or not the setting content has been confirmed. In a case where it is not detected that operation of confirming settings for the parameter ε and allowable number of API accesses have been performed in the client 12, the UI control unit 63 determines that the setting content is not confirmed, and the processing returns to Step S158.

Thereafter, processing in Steps S158 and S159 is repeatedly executed until it is determined in Step S159 that the setting content has been confirmed.

Meanwhile, in Step S159, in a case where it is detected that operation of confirming setting for the parameter ε and allowable number of API accesses have been performed in the client 12, the UI control unit 63 determines that the setting content has been confirmed, and the processing proceeds to Step S160.

In Step S160, the learning unit 61 confirms the machine learning model.

For example, the learning unit 61 confirms the machine learning model by generating or selecting the machine learning model corresponding to the set parameter ε on the basis of the result of the learning processing in Step S152. Furthermore, the learning unit 61 adds a function of detecting an attack (adversarial example) to the machine learning model as a wrapper. Moreover, in a case where a setting for disclosing a machine learning API is selected, the learning unit 61 generates a machine learning API corresponding to the confirmed machine learning model. The learning unit 61 converts the machine learning model and the machine learning API (if generated, however) into a library, and stores the machine learning model and the machine learning AP in the storage unit 55.

Alternatively, for example, the learning unit 61 confirms the machine learning model by generating or selecting the machine learning model corresponding to the set parameter ε and allowable number of API accesses, on the basis of the result of the learning processing in Step S156. Furthermore, the learning unit 61 adds a function of detecting an attack (adversarial example) to the machine learning model as a wrapper. Moreover, in a case where a setting for disclosing a machine learning API is selected, the learning unit 61 generates a machine learning API corresponding to the confirmed machine learning model. The learning unit 61 converts a file including the machine learning model, the machine learning API (if generated, however), and the allowable number of API accesses into a library, and stores the file in the storage unit 55.

Thereafter, the learning execution processing ends.

<Estimation Processing>

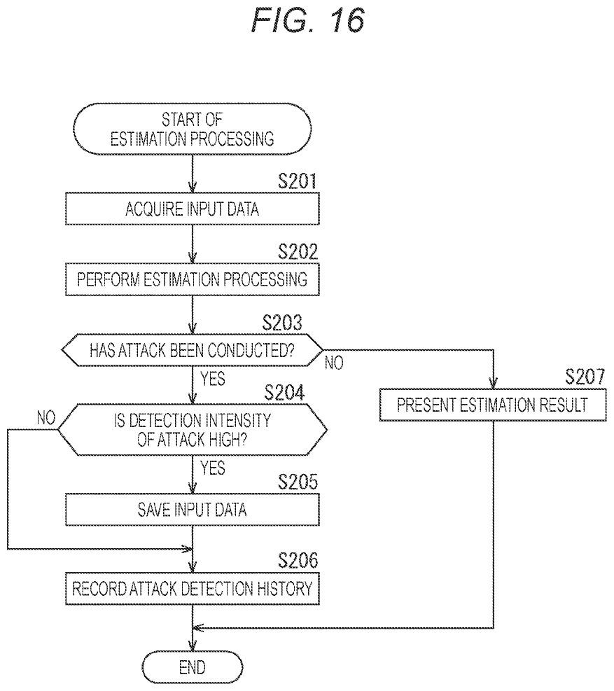

Next, estimation processing executed by the information processing system 1 will be described with reference to the flowchart in FIG. 16.

This processing is started when, for example, in the client 12, a user (hereinafter, referred to as a model user) designates a desired machine learning model or machine learning API, inputs input data, and inputs an instruction to execute estimation processing.

Note that, hereinafter, unless otherwise specified, the client 12 refers to a client 12 used by the model user in this processing.

In Step S201, the server 11 acquires input data. For example, the UI control unit 63 receives the input data and information indicating an instruction of estimation processing from the client 12 via the network 13 and the communication unit 54.

In Step S202, the estimation unit 62 performs estimation processing. Specifically, the estimation unit 62 performs processing of estimating a predetermined target by inputting the received input data to the machine learning model or machine learning API designated by the model user. Furthermore, the estimation unit 62 performs processing of detecting an adversarial example by using a method preset by the model creator.

In Step S203, the estimation unit 62 determines whether or not an attack has been conducted. In a case where detection intensity, that is the number of methods that have detected an adversarial example, is equal to or greater than a preset rejection threshold value, the estimation unit 62 determines that an attack has been conducted, and the processing proceeds to Step S204.

In Step S204, the estimation unit 62 determines whether or not the detection intensity of the attack is high. In a case where the detection intensity of the attack is equal to or higher than a preset saving threshold value, the estimation unit 62 determines that the detection intensity of the attack is high, and the processing proceeds to Step S205.

In Step S205, the server 11 saves the input data. That is, the estimation unit 62 stores the input data in the storage unit 55.

Thereafter, the processing proceeds to Step S206.

Meanwhile, in Step S204, in a case where the detection intensity of the attack is less than the saving threshold value, the estimation unit 62 determines that the detection intensity of the attack is not high, and the processing proceeds to Step 3206, skipping the processing in Step S205.

In Step S206, the estimation unit 62 records attack detection history. Specifically, for example, the estimation unit 62 generates detection history including information regarding an attack or an attacker. The detection history includes, for example, a machine learning model or machine learning API used for the estimation processing, an estimation result, access time, an access IP address, detection intensity, a handling method, or the like.

Note that the access time indicates, for example, date and time when an attack is detected. The access IP address indicates, for example, an IP address of the client 12 of a model user who has conducted an attack. The handling method indicates, for example, whether input data has been rejected or saved.

The estimation unit 62 stores the generated detection history in the storage unit 55. At this time, in a case where the input data is saved in the processing in Step S205, the estimation unit 62 associates the detection history with the input data.

Thereafter, the estimation processing ends without the estimation result being presented to the model user.

Meanwhile, in Step S203, in a case where the detection intensity is less than the rejection threshold value, the estimation unit 62 determines that no attack has been conducted, and the processing proceeds to Step S207.

In Step S207, the client 12 presents the estimation result. For example, the UI control unit 63 controls the client 12 of a service user via the communication unit 54 and the network 13 to display a screen for presenting the estimation result obtained in the processing in Step S202.

Thereafter, the estimation processing ends.

<Attack Detection History Display Processing>

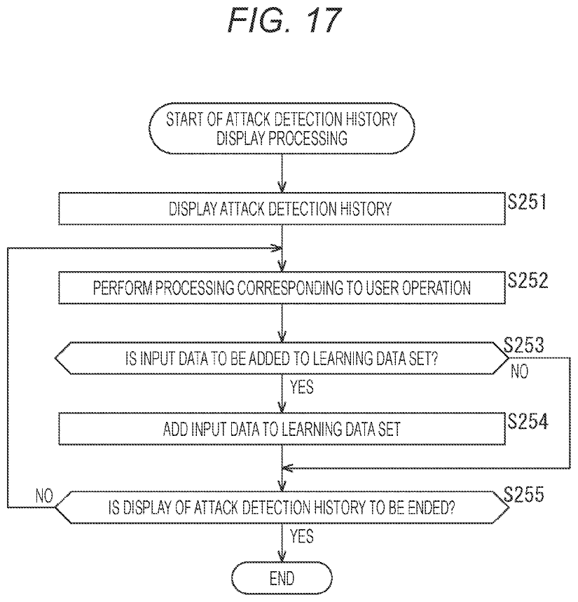

Next, attack detection history display processing executed by the information processing system 1 will be described with reference to the flowchart in FIG. 17.

This processing is started when, for example, in the client 12, the model creator designates a desired machine learning model or machine learning API, and inputs an instruction to display attack detection history.

Note that, hereinafter, unless otherwise specified, the client 12 refers to a client 12 used by the model creator in this processing.

In Step 3251, under control of the communication unit 54 and the UI control unit 63 via the network, the client 12 displays the attack detection history.

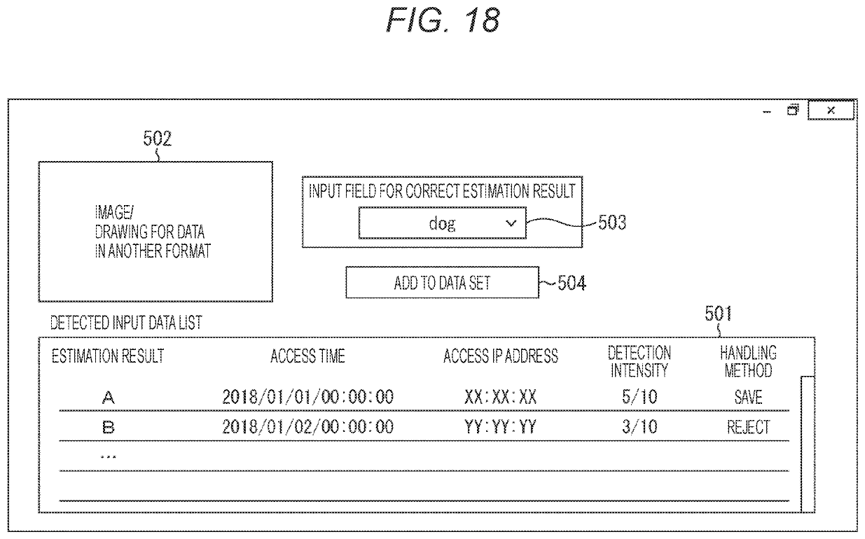

FIG. 18 illustrates an example of an attack detection history display screen for a machine learning model or machine learning API.

The attack detection history display screen includes a detected input data list display area 501, a detected data display area 502, an input field 503, and an add button 504.

The detected input data list display area 501 displays a list of input data in which an attack (adversarial example) is detected. Specifically, an estimation result, access time, an access IP address, detection intensity, and a handling method are displayed for each input data in which the attack is detected. Note that the estimation result indicates a result of estimation by the machine learning model on the basis of the input data when the attack is detected.

The detected data display area 502 displays specific content of the input data in accordance with a format of the input data selected in the detected input data list display area 501. For example, in a case where the input data is image data, the image is displayed in the detected data display area 502. For example, in a case where the input data is sound data, a spectrum waveform is displayed or actual sound is reproduced.

The input field 503 is used to input a correct estimation result for the input data.

The add button 504 is used to add the input data selected in the detected input data list display area 501 to the learning data.

Returning to FIG. 17, in Step S252, the server 11 performs processing corresponding to user operation. For example, the model creator performs various operations on the attack detection history display screen displayed on the client 12. The client 12 transmits information indicating operation content to the server 11 via the network 13. The server 11 performs processing corresponding to operation by the model creator. Furthermore, the UI control unit 63 controls display of a screen of the client 12, or the like, via the communication unit 54 and the network 13, as necessary.

In Step S253, the UI control unit 63 determines whether or not to add the input data to the learning data. In a case where it is detected that the add button 504 on the attack detection history display screen has been pressed in the client 12, the UI control unit 63 determines that the input data is to be added to the learning data, and the processing proceeds to Step S254.

In Step S254, the server 11 adds the input data to the learning data set. Specifically, via the network 13 and the communication unit 54, the UI control unit 63 acquires the input data selected in the detected input data list display area 501 in the client 12 and information indicating a correct estimation result input in the input field 503 in the client 12. The UI control unit 63 generates a data sample including the selected input data and the correct estimation result as output data, and stores the data sample in the storage unit 55.

With this arrangement, the input data detected as adversarial example is added to the learning data set. Then, relearning using the learning data set prevents an attack using the input data and similar input data as adversarial examples and enables returning of a correct estimation result.

Note that, for example, assuming that the input data is used for the learning data set in this manner, before each model user utilizes the machine learning model or the machine learning API, it is desirable to obtain, from each model user, consent for using the input data for the learning data set.

Thereafter, the processing proceeds to Step S255.

Meanwhile, in Step S253, in a case where it is not detected that the add button 504 on the attack detection history display screen has been pressed in the client 12, the input data is determined not to be added to the learning data, and the processing proceeds to Step S255, skipping the processing in Step S254.

In Step S255, the UI control unit 63 determines whether or not to end display of the attack detection history. In a case where it is determined not to end the display of the attack detection history, the processing returns to Step S252.

Thereafter, processing in Steps S252 to S255 is repeatedly executed until it is determined in Step S255 that display of the attack detection history is to end.

Meanwhile, in Step S255, in a case where it is detected that operation of ending display of the attack detection history has been performed in the client 12, the UI control unit 63 determines that the display of the attack detection history is to end, and the attack detection history display processing ends.

As described above, the model creator can easily take a security measure for a machine learning model or a machine learning API.

For example, the model creator can easily apply a method for handling information breach of confidential data on a GUI basis without performing work such as describing a complicated code by himself/herself according to a machine learning model disclosure method, and can efficiently create the machine learning model.

Furthermore, the model creator can check and set risk evaluation for an information breach of the machine learning model on the GUI basis with an easily understandable index.

Moreover, because presence of malicious input data or attacker that intentionally operates an estimation result is detected and notified to the model creator, the model creator can quickly take a measure against the attacker. Furthermore, the model creator can easily use malicious input data for learning, and can cause the machine learning model to relearn so as to robustly perform correct estimation on the malicious input data.

Moreover, for example, by using a disclosed data set, it is possible to take a strong measure against an information breach as compared to a conventional method for adding noise in a post-processing manner after creating a machine learning model.

### 3. Modifications

Hereinafter, modifications of the above-described embodiment of the present technology will be described.

A configuration of the information processing system 1 described above is an example, and can be changed as appropriate.

For example, the server 11 may include a plurality of information processing devices and share processing.

Furthermore, part or all of the processing by the server 11 described above may be performed by the client 12. For example, the client 12 may have functions of the server 11 in FIG. 3, and the client 12 alone may perform all of the learning processing in FIG. 4, the estimation processing in FIG. 16, and the attack detection history display processing in FIG. 17.

Moreover, for example, a library of a machine learning model generated by the server 11 may be transmitted to the client 12 of the model creator so as to be used by the client 12 alone.

Furthermore, most of the differential privacy mechanisms for machine learning currently proposed in research are premised on an identification task, but it is conceivable that a method applicable to a regression task will appear in the future. The present technology can implement a similar function also for a regression task by adding a method to be adopted.

### 4. Others

<Configuration Example of Computer>

The above-described series of processing by the server 11 and the client 12 can be executed by hardware or can be executed by software. In a case where a series of processing is executed by software, a program included in the software is installed on a computer. Here, the computer includes, a computer incorporated in dedicated hardware, a general-purpose personal computer for example, which is capable of executing various kinds of functions by installing various programs, or the like.

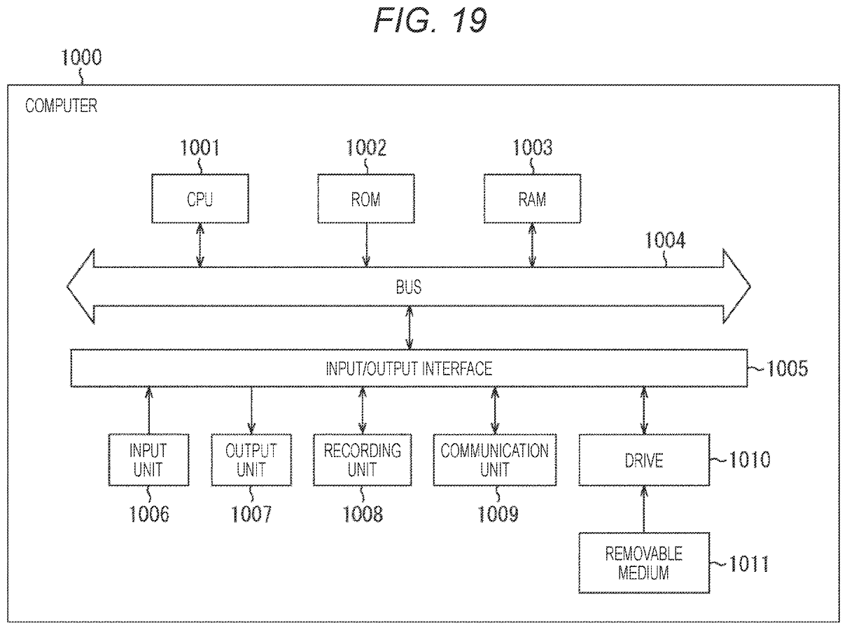

FIG. 19 is a block diagram illustrating a configuration example of hardware of a computer that executes the above-described series of processing with a program.

In a computer 1000, a central processing unit (CPU) 1001, a read only memory (ROM) 1002, and a random access memory (RAM) 1003 are mutually connected by a bus 1004.

Moreover, an input/output interface 1005 is connected to the bus 1004. An input unit 1006, an output unit 1007, a recording unit 1008, a communication unit 1009, and a drive 1010 are connected to the input/output interface 1005.

The input unit 1006 includes an input switch, a button, a microphone, an image sensor, or the like. The output unit 1007 includes a display, a speaker, or the like. The recording unit 1008 includes a hard disk, a non-volatile memory, or the like. The communication unit 1009 includes a network interface, or the like. The drive 1010 drives a removable recording medium 1011 such as a magnetic disk, an optical disk, a magneto-optical disk, or a semiconductor memory.

In the computer 1000 configured as above, the series of processing described above is executed by the CPU 1001 loading, for example, a program recorded in the recording unit 1008 to the RAM 1003 via the input/output interface 1005 and the bus 1004 and executing the program.

A program executed by the computer 1000 (CPU 1001) can be provided by being recorded on the removable recording medium 1011 as a package medium, or the like, for example. Furthermore, the program can be provided via a wired or wireless transmission medium such as a local area network, the Internet, or digital satellite broadcasting.

In the computer 1000, the program can be installed on the recording unit 1008 via the input/output interface 1005 by attaching the removable recording medium 1011 to the drive 1010. Furthermore, the program can be received by the communication unit 1009 via the wired or wireless transmission medium and installed on the recording unit 1008. In addition, the program can be installed on the ROM 1002 or the recording unit 1008 in advance.

Note that, the program executed by the computer may be a program that is processed in time series in an order described in this specification, or a program that is processed in parallel or at a necessary timing such as when a call is made.

Furthermore, in the present specification, the system means a set of a plurality of components (devices, modules (parts), or the like) without regard to whether or not all the components are in the same housing. Therefore, a plurality of devices housed in separate housings and connected via a network, and one device housing a plurality of modules in one housing are both systems.

Moreover, an embodiment of the present technology is not limited to the above-described embodiment, and various changes can be made without departing from the scope of the present technology.

For example, the present technology can have a configuration of cloud computing in which one function is shared and processed jointly by a plurality of devices via a network.

Furthermore, each step described in the above-described flowcharts can be executed by one device, or can be executed by being shared by a plurality of devices.

Moreover, in a case where a plurality of pieces of processing is included in one step, the plurality of pieces of processing included in the one step can be executed by being shared by a plurality of devices, in addition to being executed by one device.

<Example of Configuration Combination>

The present technology can have the following configurations.

(1)

An information processing method including,

by an information processing system including one or more information processing devices,

controlling a user interface for performing a setting related to security of a machine learning model, and

generating the machine learning model corresponding to content set via the user interface.

(2)

The information processing method according to (1),

in which the setting related to security includes a setting related to security for at least one of a breach of information regarding data used for learning by the machine learning model or operation of a result of an estimation by the machine learning model.

(3)

The information processing method according to (2),

in which the setting related to security includes a setting related to a differential privacy mechanism applied to the machine learning model.

(4)

The information processing method according to (3),

in which the setting related to a differential privacy mechanism includes a setting for a parameter for the differential privacy mechanism.

(5)

The information processing method according to (4),

in which the information processing system controls display of a first graph illustrating a characteristic of estimation accuracy of the machine learning model with respect to the parameter.

(6)

The information processing method according to (5),

the information processing method enabling a setting for the parameter by selection of a point on the first graph.

(7)

The information processing method according to (5) or (6),

in which the information processing system further controls display of a second graph illustrating a characteristic of estimation accuracy of the machine learning model with respect to testing power based on the parameter.

(8)

The information processing method according to any one of (3) to (7),

in which the setting related to security includes a setting for the number of accesses with respect to an application programming interface (API) for using the machine learning model.

(9)

The information processing method according to (8),

in which the information processing system controls display of a graph illustrating a characteristic of information confidentiality of the machine learning model with respect to an upper limit value of the number of accesses of the API.

(10)

The information processing method according to any one of (3) to (9),

in which the setting related to security includes a setting for whether or not to use a disclosed data set in learning by the machine learning model, and

the information processing system sets a learning method of the machine learning model on the basis of the whether or not to use the disclosed data set.

(11)

The information processing method according to (10),

in which the setting related to security includes a setting for whether to disclose the machine learning model or the API for using the machine learning model, and

the information processing system enables a setting for the whether or not to use the disclosed data set in a case where the API is to be disclosed, and disables the setting for the whether or not to use the disclosed data set and fixes the setting to a setting for using the disclosed data set in a case where the machine learning model is to be disclosed.

(12)

The information processing method according to (10) or (11),

in which the information processing system notifies of a risk of an information breach in a case where non-use of the disclosed data set is selected.

(13)

The information processing method according to any one of (2) to (12),

in which the setting related to security includes a setting for a detection method to be applied to detection of an adversarial example.

(14)

The information processing method according to (13),

in which the setting related to security includes a setting for intensity of detection of an adversarial example.

(15)

The information processing method according to (13) or (14),

in which the information processing system performs processing of detecting an adversarial example on the basis of the set detection method.

(16)

The information processing method according to any one of (13) to (15),

in which the information processing system sets a learning method of the machine learning model on the basis of the set detection method.

(17)

The information processing method according to any one of (13) to (16),

in which the information processing system controls display of attack detection history using an adversarial example as input data.

(18)

The information processing method according to (17),

in which the information processing system adds the input data selected in the detection history to data to be used for learning by the machine learning model.

(19)

An information processing device including

a user interface control unit that controls a user interface for performing a setting related to security of a machine learning model, and

a learning unit that generates the machine learning model corresponding to content set via the user interface.

(20)

A program for causing a computer to execute processing including

controlling a user interface for performing a setting related to security of a machine learning model, and

generating the machine learning model corresponding to content set via the user interface.

Note that the effects described herein are only examples, and the effects of the present technology are not limited to these effects. Additional effects may also be obtained.

### REFERENCE SIGNS LIST

10 Information processing system
11 Server
12 Client
13 Network
52 Information processing unit
61 Learning unit
62 Estimation unit
63 UI control unit

1. An information processing method comprising,
by an information processing system including one or more information processing devices:
controlling a user interface for performing a setting related to security of a machine learning model; and
generating the machine learning model corresponding to content set via the user interface.

2. The information processing method according to claim 1,
wherein the setting related to security includes a setting related to security for at least one of a breach of information regarding data used for learning by the machine learning model or operation of a result of an estimation by the machine learning model.

3. The information processing method according to claim 2,
wherein the setting related to security includes a setting related to a differential privacy mechanism applied to the machine learning model.

4. The information processing method according to claim 3,
wherein the setting related to a differential privacy mechanism includes a setting for a parameter for the differential privacy mechanism.

5. The information processing method according to claim 4,
wherein the information processing system controls display of a first graph illustrating a characteristic of estimation accuracy of the machine learning model with respect to the parameter.

6. The information processing method according to claim 5,
the information processing method enabling a setting for the parameter by selection of a point on the first graph.

7. The information processing method according to claim 5,
wherein the information processing system further controls display of a second graph illustrating a characteristic of estimation accuracy of the machine learning model with respect to testing power based on the parameter.

8. The information processing method according to claim 3,
wherein the setting related to security includes a setting for the number of accesses with respect to an application programming interface (API) for using the machine learning model.

9. The information processing method according to claim 8,
wherein the information processing system controls display of a graph illustrating a characteristic of information confidentiality of the machine learning model with respect to an upper limit value of the number of accesses of the API.

10. The information processing method according to claim 3,
wherein the setting related to security includes a setting for whether or not to use a disclosed data set in learning by the machine learning model, and
the information processing system sets a learning method of the machine learning model on a basis of the whether or not to use the disclosed data set.

11. The information processing method according to claim 10,
wherein the setting related to security includes a setting for whether to disclose the machine learning model or the API for using the machine learning model, and
the information processing system enables a setting for the whether or not to use the disclosed data set in a case where the API is to be disclosed, and disables the setting for the whether or not to use the disclosed data set and fixes the setting to a setting for using the disclosed data set in a case where the machine learning model is to be disclosed.

12. The information processing method according to claim 10,
wherein the information processing system notifies of a risk of an information breach in a case where non-use of the disclosed data set is selected.

13. The information processing method according to claim 2,
wherein the setting related to security includes a setting for a detection method to be applied to detection of an adversarial example.

14. The information processing method according to claim 13,
wherein the setting related to security includes a setting for intensity of detection of an adversarial example.

15. The information processing method according to claim 13,
wherein the information processing system performs processing of detecting an adversarial example on a basis of the set detection method.

16. The information processing method according to claim 13,
wherein the information processing system sets a learning method of the machine learning model on a basis of the set detection method.

17. The information processing method according to claim 13,
wherein the information processing system controls display of attack detection history using an adversarial example as input data.

18. The information processing method according to claim 17,
wherein the information processing system adds the input data selected in the detection history to data to be used for learning by the machine learning model.

19. An information processing device comprising:
a user interface control unit that controls a user interface for performing a setting related to security of a machine learning model; and
a learning unit that generates the machine learning model corresponding to content set via the user interface.

20. A program for causing a computer to execute processing comprising:
controlling a user interface for performing a setting related to security of a machine learning model; and
generating the machine learning model corresponding to content set via the user interface.
